(19) United States
(12) Patent Application Publication
(10) Pub. No.: US 2021/0129011 A1
(43) Pub. Date: May 6, 2021

(54) Alpha Card

(71) Applicant: Kurt Althoff, Jacksonville, FL (US)

(72) Inventor: Kurt Althoff, Jacksonville, FL (US)

(21) Appl. No.: 17/086,886

(22) Filed: Nov. 2, 2020

Related U.S. Application Data
(60) Provisional application No. 62/929,915, filed on Nov. 3, 2019.

(51) Int. Cl. A63F 11/00

(52) U.S. Cl. CPC A63F 11/0074

(57) ABSTRACT

A game where individuals in a relationship can wager a bet that in turn wins The Alpha Card granting them an ultimate decision regarding a conflict/decision in their respective relationship. The Alpha Card is won by betting on any subject of discussion. Once the bet is accepted by the opposing party(ies), the research is done to assess who won the bet. The Alpha Card is granted to the winner and they may hold on to the card until they are ready to settle a conflict or override a decision. There is no time limit on how soon they have to use The Alpha Card. Once The Alpha Card is played, it returns to neutral so that it can be won again. The game can be utilized by two or more individuals. All bets and outcomes of said bets are recorded in The Alpha Card journal that comes with the book or mobile application.

### TECHNICAL FIELD

The present invention is a game played and used by people in relationships. The net benefit of the game is to tip the scales in future potential disagreements. The acts as a catalyst for finding resolution. The associated journal acts as a record of each individual wager and use of the Alpha Card. The Alpha Card has to be earned by wager.

### SUMMARY OF THE INVENTION

The Alpha Card is a game that allows two people to resolve conflicts objectively and humorously based on the concept that whoever “bears The Alpha Card Calls the Shots.” The game is not played in a single sitting. Rather, it's played throughout a relationship once players agree to the Contracted Terms. The two players involved in an Alpha Card transaction are The Bet Maker and The Bet Taker, The Bet Maker is usually betting on something commonplace and factual that can be proven with minimal research. For example, who an actor is in a specific movie, what year an event occurred, the time the local grocery closes, Imagine those common transactions where two people find themselves at odds, while both insisting they are correct. In the last example, Bet Maker: “I'll bet you The Alpha Card that the grocery closes at 10 tonight, not 11.” Bet Taker: “Bet accepted”. Research ensues and whoever wins the bet becomes The Bearer of The Alpha Card. Possession of The Alpha Card allows the Bearer to be in charge of a single decision in the future, thus Calling the Shot. The Bearer might Call the Shot for situations as mundane as what restaurant to go to for dinner, or more impactful, such as dictating a vacation destination or enforcing a protocol for how to load the dishwasher. (It's recommended that the Call the Shots is never used to manipulate or coerce, or for life-altering decisions like having another child or moving to another country. That's too much responsibility for The Alpha Card!) After a Call the Shots play, The Alpha Card goes back into Neutral position until the next bet is made and accepted. All time frames for how long TAC has be in Neutral or how long it can be held by The Bearer before Calling the Shot are determined by the players. These transactions require strategy! Bets do not have to be accepted—it's a matter of each players' confidence in their own correctness. Bluffing is effective. Included with The Alpha Card is a journal to track the details of all transactions, thus creating a keepsake of personal relationship history.

### DETAILED DESCRIPTION

The Alpha Card is placed in Neutral Position. Meaning nobody has possession. Possession of the card is earned through the winning of a bet, as in the example above. The bet is placed by the Bet Maker and must be accepted by the Bet Taker—or there is no bet.
Generally, these bets are over inconsequential matters, like the correct lyrics to a song, the operating hours of a local store, or if the leftovers will fit into the selected food storage container, the name of a particular actor, etc. . . .
The Bet Winner becomes the Bearer of The Alpha Card.
The Bearer of The Alpha Card receives 1 play—that is, 1 circumstance where they Call the Shots.
Call the Shots is useful in a variety of circumstances! Do not want to go the restaurant your partner chooses? If you are the card Bearer, play The Alpha Card and you overrule them. Without argument. Are you the Bearer and want to drive instead of fly for that upcoming weekend trip? Then gas up the sedan because you can use your play for that—no whines or pines.
After The Alpha Card has been played, it returns to Neutral Position until the next bet is offered, accepted, and a winner is determined.
Use the enclosed pad to record Bets and Call the Shots. Just imagine the fun you'll have years
from now, recounting the many times The Alpha Card added fun and humor to potentially frustrating disagreements.
Bets can only be made while the card is in Neutral Position.
No party is required to accept a bet. Should the potential Bet Taker feel it is not in their best interest to accept, they simply decline. This step is a test of confidence for both parties.
Specific time frames for how long a Bearer may hold on to The Alpha Card before playing it are mutually agreed upon by both parties in advance.

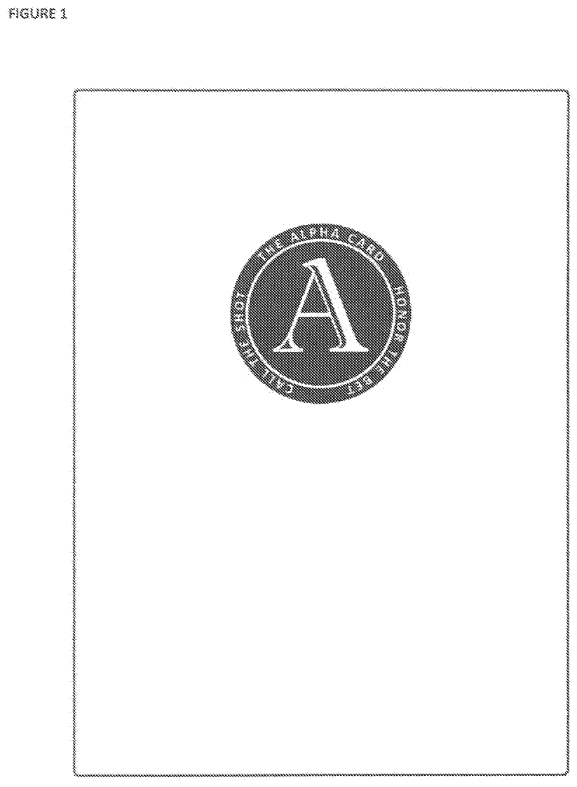

FIG. 1: Front of the journal is used to define where the respective uses and plays of The Alpha Card game piece are recorded.

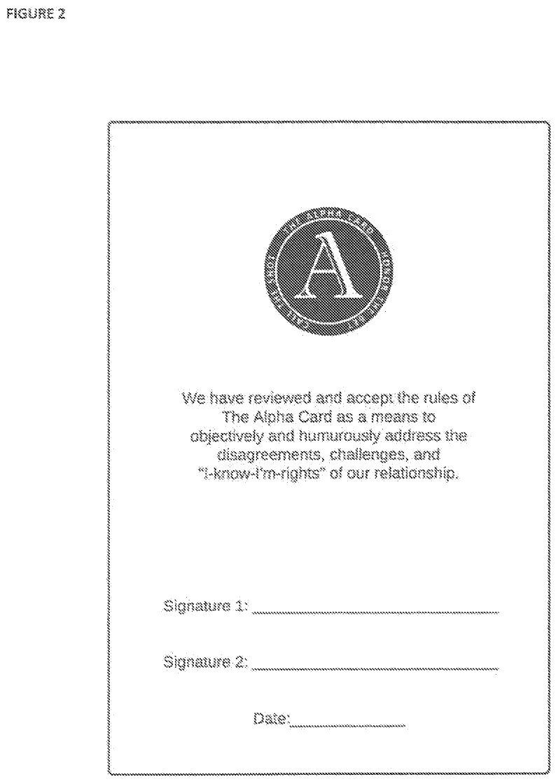

FIG. 2: First page of the journal is used to sign off and agree to the rules of the game.

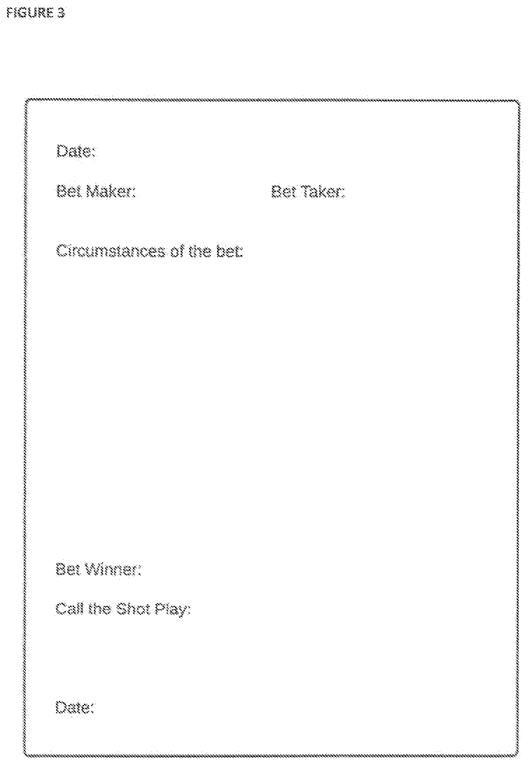

FIG. 3: Second through the fortieth page of the journal is used to record the circumstances surrounding each accepted bet by the parties involved.

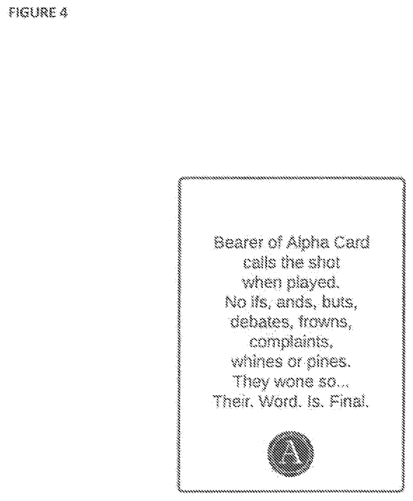

FIG. 4: The front of the Alpha Card itself serves as the game piece and represents the bearer's tool to essentially veto the other parties' directives.

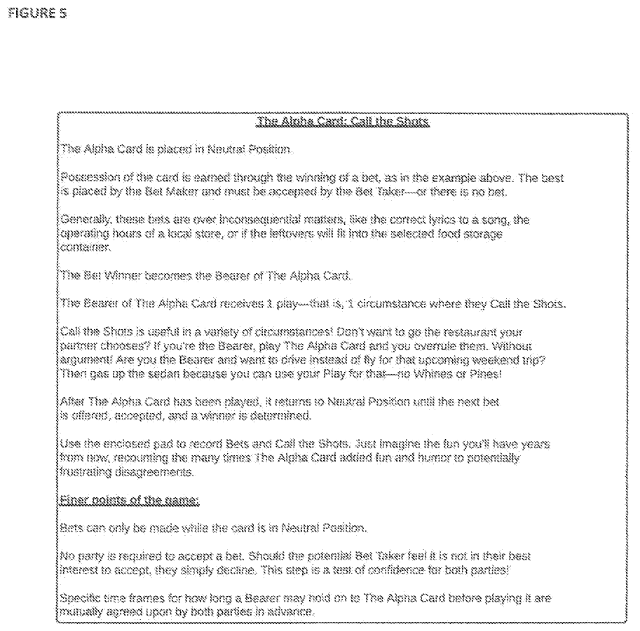

FIG. 5: The instructions card explains the rules of engagement with regards to The Alpha Card and The Alpha Card journal.

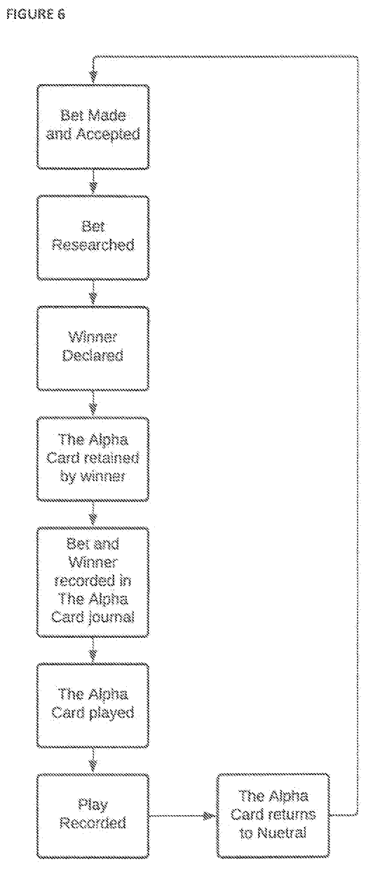

FIG. 6: The process flow explains in detail how the card moves from neutral, to the player, and back to neutral.

I claim:

1. A relationship-based game comprised of The Alpha Card which grants the bearer the ability to overturn the participating players directives or choices with limited complaint from respective player.

2. A relationship-based game comprised of The Alpha Card journal and pages therein are used to record participating players names, signatures, dates with respect to the bet that was made, and use of The Alpha Card.

3. The relationship-based game can be applied to any type of relationship where all parties agree to said rules.
